(19) United States
(12) Patent Application Publication
(10) Pub. No.: US 2023/0061754 A1
(43) Pub. Date: Mar. 2, 2023

(54) SYSTEMS AND METHODS FOR DETERMINING DELIVERY TIME INFORMATION FOR A PRODUCT SOLD ONLINE

(71) Applicant: SHOPIFY INC., Ottawa (CA)

(72) Inventor: ASHER WRIGHT, Victoria (CA)

(21) Appl. No.: 17/464,830

(22) Filed: Sep. 2, 2021

(51) Int. Cl. G06Q 10/08

(52) U.S. Cl. CPC G06Q 10/0833

(57) ABSTRACT

When a user is interacting with web content of an online store/marketplace, it may be desirable for the web content to display information related to the delivery time of the product. Determining the delivery time information in real-time may be complex and unreliable due to the number of factors incorporated into the computation and because one or more of the factors might not be known or inferable until immediately before generation of the delivery time information. In some embodiments, the delivery timeline may be partitioned into non-overlapping segments, and segment data structures may be configured for each segment. In some embodiments, a master data structure is generated based on the segment data structures that includes the probability of different delivery times for given combinations of input data. In some embodiments, the web content may include delivery time information based on the probabilities in the master data structure.

### FIELD

The present application relates to determining information relating to the delivery time of a product sold online.

### BACKGROUND

In an e-commerce system, a user can purchase an item that is physically located far away from the user. The product must be shipped to the user. The delivery time can vary depending on many factors.

When the user is interacting with the web content of an online store or online marketplace, it is sometimes desirable for the web content to display information related to the delivery time of the product. For example, when a user requests a product page (i.e. a web page that conveys information related to a product offered for sale), it may be desired that the returned web content include information related to delivery time of that product. In another example, during an online checkout process it may be desired that the generated web content includes information related to delivery time of the product.

### SUMMARY

The computer generating the web content is faced with the following technical problem. The information related to the delivery time of the product needs to be reliable. For example, the information might form the basis of a promise provided to the user ahead of purchase, e.g. “Purchase now and receive the product by Wednesday”. However, generating reliable delivery time information is complex to implement and particularly computationally complex because of the multiple factors ideally incorporated into the computation, e.g. delivery location, online store from which product is to be purchased, fulfillment center from which the product will ship, etc. Moreover, some of this information is not known or inferable until immediately before the delivery time information must be generated. For example, a request for web content received from a user device may provide some of the information required for the computation, and in response to that request for web content the computer must include the delivery time information in the web content. The computation must be executed in the time between receiving the request for the web content and returning the web content, which in the context of online web browsing is a very small window.

For example, a user clicks a hyperlink for a product page. The request for the product page (e.g. HTTP or HTTPS request) sent from the user device includes an identity of the product. In response, the computer needs to retrieve the identity of the product from the request (and possibly retrieve the IP address of the user's device to infer the delivery location), and then compute delivery time information. The computer then needs to include that delivery time information in response to the request so that the loaded webpage on the user device includes the delivery time information. The computation must be made in the window of time between receiving the request for the web page and returning the web page. In another example, shipping information received during the checkout process might need to be immediately used to update the checkout webpage to display the delivery time information.

In some embodiments, a data structure (e.g. look-up table) is generated that includes the probability of different delivery times for given combinations of input data. The data structure may be generated offline and then used during web browsing to quickly generate more reliable delivery time information based on data in a request for web content.

In an embodiment, there is provided a computer-implemented method. The method may include steps of receiving, from a user device over a network, a request for content (e.g. web content) associated with a product and replying to the request. The replying may include, extracting, from a data structure, a probability that the product is delivered within a specific product delivery time window. The data structure may be based on: partitioning a delivery timeline of the product into non-overlapping segments; for each segment of the non-overlapping segments: computing segment probabilities, such that at least two of the segment probabilities are each associated with a respective different time duration for completing the segment; and, combining the segment probabilities of the segments to form the data structure, such that an output obtainable from the data structure includes a plurality of probabilities, each of the plurality of probabilities corresponding to a respective different product delivery time window. The replying may further include: based on the probability extracted from the data structure, generating an indication (e.g. a message) including delivery time information relating to the product; incorporating the indication into the content; and, transmitting the content over the network for display on the user device.

In some embodiments, the probability extracted from the data structure may be extracted based on data in the request.

In some embodiments, the partitioning the delivery timeline may include configuring a plurality of intermediary data structures. Each one of the intermediary data structures may correspond to a respective non-overlapping segment of the delivery timeline. Each one of the intermediary data structures may provide an output based on a respective set of inputs, in which the output may be the segment probabilities for the respective non-overlapping segment.

In some embodiments, the combining the segment probabilities may include multiplying an intermediary data structure probability output by one intermediary data structure with a corresponding intermediary data structure probability output by one or more or each of the other intermediary data structures.

In some embodiments, the respective set of inputs of one of the intermediary data structures may be different from the respective set of inputs of another of the intermediary data structures. In some embodiments, the inputs to the data structure may include a union of all of the inputs to the intermediary data structures.

In some embodiments, inclusion of a delivery time of the product as part of the indication may be determined based on the probability extracted from the data structure being within a particular confidence interval.

In some embodiments, the segment probabilities for each non-overlapping segment may be computed based on historical time duration data.

In some embodiments, inclusion of a delivery time of the product as part of the indication may be determined based on a number of previously provided product delivery times being within a particular range.

In some embodiments, the non-overlapping segments may correspond to partitions in time including at least one of: a time an order is placed to a time a fulfillment center is selected and notified; the time the order is placed to a time the order is received at a fulfillment network; the time the order is received at the fulfillment network to the time the fulfillment network selects and notifies the fulfillment center; the time the fulfillment center is notified to a time when a packaged product is picked up by a carrier; the time the fulfillment center is notified to a time the product is picked and packaged; the time the product is picked and packaged to the time when the packaged product is picked up by the carrier; or, the time the product is picked up by the carrier to a time when the product is delivered.

In some embodiments, the content may be at least one of a product webpage or a checkout webpage.

A system is also disclosed that is configured to perform the methods disclosed herein. For example, the system may include a memory to store a data structure and at least one processor to carry out the method steps including receiving a request for content associated with a product and replying to the request.

In another embodiment, there is provided a computer readable medium having stored thereon computer-executable instructions that, when executed by a computer, cause the computer to perform operations of the methods disclosed herein.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 illustrates a home page of an administrator, according to one embodiment;

FIG. 3 illustrates the e-commerce platform of FIG. 1, but with a delivery time information generator, according to one embodiment;

FIG. 4 illustrates a system for generating information relating to the delivery time of a product, according to one embodiment;

FIGS. 5 to 7 illustrate examples of look up tables (LUTs) providing segment probabilities for non-overlapping segments of the delivery timeline, according to some embodiments;

FIGS. 8 and 9 illustrate a trellis graph illustrating input/output connections between the LUTs of FIGS. 5 to 7, according to some embodiments;

FIGS. 10 and 11 illustrate a master LUT generated from the trellis graph of FIGS. 8 and 9, according to some embodiments;

FIG. 12 illustrates an example of a user interface for displaying the information relating to the delivery time of a product on a checkout page, according to one embodiment;

FIG. 13 illustrates an example of a user interface for displaying the information relating to the delivery time of a product on a product page, according to one embodiment; and,

FIG. 14 illustrates steps of a computer-implemented method, according to one embodiment.

### DETAILED DESCRIPTION

For illustrative purposes, specific example embodiments will now be explained in greater detail below in conjunction with the figures.

### An Example e-Commerce Platform

Although integration with a commerce platform is not required, in some embodiments, the methods disclosed herein may be performed on or in association with a commerce platform such as an e-commerce platform. Therefore, an example of a commerce platform will be described.

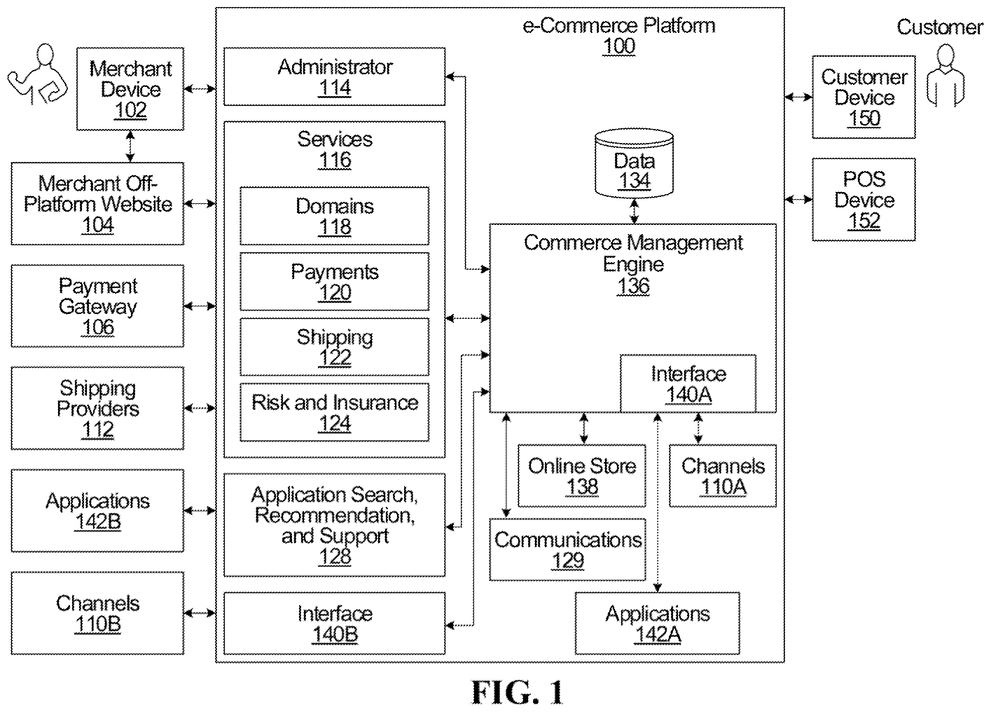

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

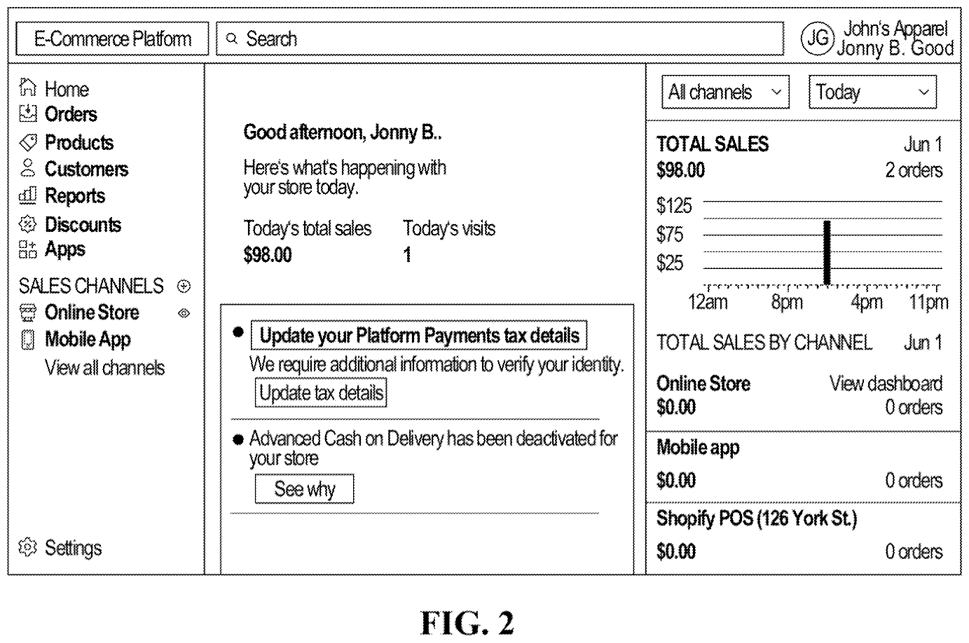

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Generating Delivery Time Information Using the e-Commerce Platform 100

A customer may desire to know an amount of time required for a product that may be purchased online to be delivered to them. The expected delivery time may influence the customer's decision to purchase the product from a particular online vendor due to the expectation of receiving a product within a particular timeframe. As such, a system for generating delivery time information might allow for delivery time information, such as a delivery promise or an expected delivery time, to be provided to the customer while, for instance, browsing a product page of an online store/marketplace, and/or within channels relating to selling via a search engine or social media, and/or while completing an online checkout process. The preceding list is not limiting, and delivery promise or expected delivery time may also be provided to the customer elsewhere while online.

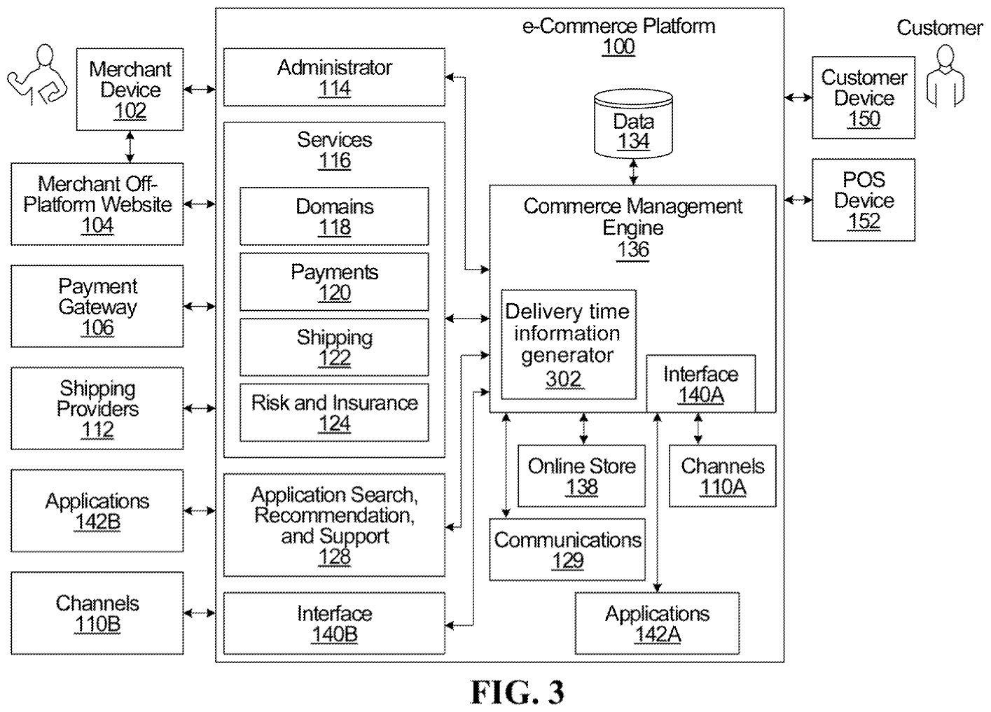

FIG. 3 illustrates the e-commerce platform 100 of FIG. 1, but with the addition of a delivery time information generator 302. The delivery time information generator 302 may be embodied as part of the commerce management engine 136. The delivery time information generator 302 performs the methods disclosed herein. For example, the delivery time information generator 302 may receive requests for content (e.g. web content such as a web page) associated with a product from a user device, such as customer device 150 in the manner described herein. The delivery time information generator 302 may also reply to the request as described herein.

The delivery time information generator 302 may be implemented by one or more general-purpose processors that execute instructions stored in a memory (e.g. in memory that is part of the data 134) or stored in another non-transitory computer-readable medium. The instructions, when executed, cause the delivery time information generator 302 to perform the operations of the delivery time information generator 302, e.g., operations relating to extracting, from a data structure, a probability that a product is delivered within a specific product delivery time window, generating an indication including delivery time information relating to the product based on the extracted probability, incorporating the indication into the requested content, and transmitting the content to a user device. Alternatively, some or all of the delivery time information generator 302 may be implemented using dedicated circuitry, such as an application specific integrated circuit (ASIC), a graphics processing unit (GPU), or a programmed field programmable gate array (FPGA). In some embodiments, the order message generator 302 may be located inside the e-commerce platform 100 but external to, and coupled to, the commerce management engine 136. In some embodiments, the order message generator 302 may instead be located externally to the e-commerce platform 100 and possibly coupled to the commerce management engine 136.

Although the delivery time information generator 302 in FIG. 3 is illustrated as a distinct component of the e-commerce platform 100 in commerce management engine 136, this is only an example. The delivery time information generator 302 could also or instead be provided by another component residing within or external to the e-commerce platform 100. In some embodiments, either or both of the applications 142A-B may provide the delivery time information generator 302 that implements the functionality described herein. The location of the delivery time information generator 302 is implementation specific. In some implementations, the delivery time information generator 302 is provided at least in part by an e-commerce platform, either as a core function of the e-commerce platform or as an application or service supported by or communicating with the e-commerce platform.

In some embodiments, at least a portion of delivery time information generator 302 could be implemented in a user device (e.g. customer device 150). For example, the customer device 150 could store and run at least some of the delivery time information generator 302 locally as a software application.

Although the embodiments described herein may be implemented using the delivery time information generator 302 in e-commerce platform 100, the embodiments are not limited to the specific e-commerce platform 100 of FIGS. 1 to 3 and could be used in connection with any e-commerce platform. Also, the embodiments described herein need not necessarily be implemented in association with an e-commerce platform, but might instead be implemented as a standalone component or service. Therefore, the embodiments below will be described more generally.

### Example System for Determining Delivery Time Information

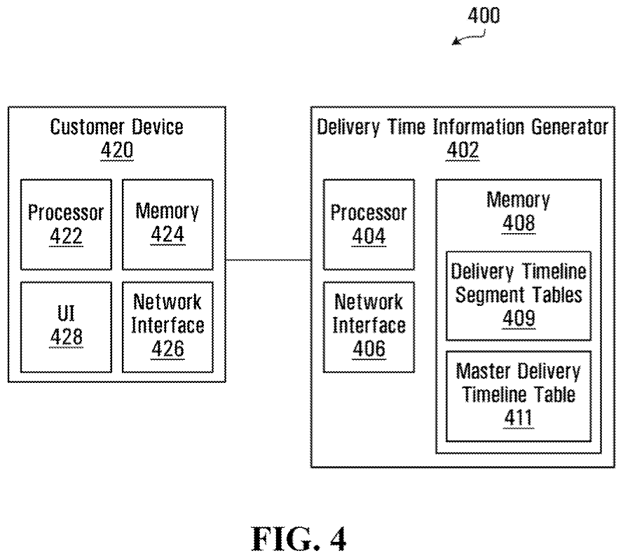

FIG. 4 illustrates a system 400 for generating information relating to the delivery time of a product, according to one embodiment. The system 400 includes a delivery time information generator 402 and a customer device 420. The customer device 420 may alternatively or more generally be referred to as a user device.

The delivery time information generator 402 of system 400 includes a processor 404, a network interface 406, and a memory 408. The processor 404 directly performs, or instructs the delivery time information generator 402 to perform, the operations described herein of the delivery time information generator, e.g., operations such receiving a request for content (e.g. web content) from the customer deice 420 and replying to the request, etc. The processor 404 may be implemented by one or more general purpose processors that execute instructions stored in a memory (e.g. in memory 408) or stored in another computer-readable medium. The instructions, when executed, cause the processor 404 to directly perform, or instruct the delivery time information generator 402 to perform the operations of the delivery time information generator described herein. In other embodiments, the processor 404 may be implemented using dedicated circuitry, such as a programmed FPGA, a GPU, or an ASIC.

The network interface 406 is for communicating over a network, e.g. to communicate with the customer device 420 described below. The network interface 406 may be implemented as a network interface card (NIC), and/or a computer port (e.g. a physical outlet to which a plug or cable connects), and/or a network socket, etc., depending upon the implementation. The delivery time information generator 402 further includes a memory 408. A single memory 408 is illustrated in FIG. 4, but in implementation the memory 408 may be distributed.

The memory 408 includes delivery timeline segment tables 409, which includes delivery timeline information for particular non-overlapping segments in the delivery timeline of a product, as described herein. As well, the memory 408 includes a master delivery timeline table 411, which includes delivery timeline information based on the data provided by a combination of some or all of the data in the delivery timeline segment tables 409, as described herein.

In some embodiments, the processor 404, memory 408, and/or network interface 406 may be located outside of the delivery time information generator 402.

A plurality of customer devices may communicate with the delivery time information generator 402 over a network. For example, a customer device may send a request for content relating to a product sold online to the delivery time information generator 402. For ease of explanation, only a single customer device, customer device 420, is shown in FIG. 1. The customer device 420 may be customer device 150 shown in FIG. 1 if the delivery time information generator 402 is part of the e-commerce platform 100.

The customer device 420 includes a processor 422, a memory 424, a network interface 426, and a user interface 428. The processor 422 directly performs, or instructs the customer device 420 to perform, the operations of the customer device 420 described herein, e.g. sending requests for content relating to a product to the delivery time information generator 402, and receiving back the reply that includes the content having an indication including delivery time information relating to the product, which is displayed via the user interface 428 of the customer device 420. The processor 422 may be implemented by one or more general purpose processors that execute instructions stored in a memory (e.g. memory 424) or stored in another computer-readable medium. The instructions, when executed, cause the processor 422 to directly perform, or instruct customer device 420 to perform, the customer device operations described herein. In other embodiments, the processor 422 may be implemented using dedicated circuitry, such as a programmed FPGA, a GPU, or an ASIC.

The network interface 426 is for communicating over a network, e.g. to communicate with the delivery time information generator 402. The structure of the network interface 426 will depend on how the customer device 420 interfaces with the network. For example, if the customer device 420 is a mobile phone, laptop, or tablet, the network interface 426 may comprise a transmitter/receiver with an antenna to send and receive wireless transmissions to/from the network. If the customer device 420 is a personal computer connected to the network with a network cable, the network interface 426 may comprise a network interface card (NIC), and/or a computer port (e.g. a physical outlet to which a plug or cable connects), and/or a network socket, etc., depending upon the implementation.

The memory 424 may be single memory 424 (as illustrated), but in implementation the memory 424 may be distributed.

The user interface 428 may be implemented as a display screen (which may be a touch screen), and/or a keyboard, and/or a mouse, etc., depending upon the implementation.

In some embodiments, the delivery time information generator 402 is part of an e-commerce platform, e.g. e-commerce platform 100. For example, the delivery time information generator 402 may be delivery time information generator 302 illustrated in FIG. 3. However, this is not necessary. For example, the delivery time information generator 402 may be implemented as a stand-alone component or service that is external to an e-commerce platform. In some embodiments, either or both of the applications 142A-B of FIG. 3 may provide the delivery time information generator 402 in the form of a downloadable application that is available for installation, e.g. in relation to a customer account. In other embodiments, the delivery time information generator 402 may be implemented on or in association with a computer system that is not an e-commerce platform. In some embodiments, some operations of the delivery time information generator 402 described herein could potentially be implemented in part on/by a customer device, such as customer device 420.

### Providing Delivery Timeline Information Relating to a Product

To try to improve accuracy and reliability in providing delivery timeline information relating to a product, and/or to try to reduce complexity in providing the delivery timeline information during real-time web browsing, a delivery timeline may be partitioned into a plurality of segments. An independent computation may be performed for each segment. The output of the computation for each segment may be the probability of different durations of time taken to complete that segment. The input to the computation of each segment may be a reduced set of input factors that are most influential for just that segment. The segments may then be combined to form a data structure (e.g. a lookup table) that outputs the probability of how long it will take to deliver the product within different windows of time, for a given set of inputs (e.g. for a given product ID, delivery location, etc.). Due to the isolation of only relevant factors and input signals for each segment, better predictions may be made in the computation of predictions for each of the segments.

In one example, the delivery timeline is partitioned into three non-overlapping segments:

(1) time from when the order is placed to when a fulfillment center is selected and notified;

(2) time from when the fulfillment center is notified to when the packaged product is picked up by the carrier;

(3) time from pickup by the carrier to delivery.

A partition into three segments is only a simplified example and is selected for ease of explanation. For example, segment (1) may instead be separated into two non-overlapping segments: time from when the order is placed to when the order is received at the fulfillment network, and time from when the order is received at the fulfillment network to when the fulfillment network selects and notifies a fulfillment center. As another example, segment (2) may instead be separated into two non-overlapping segments: time from when the fulfillment center is notified to when the product is picked and packaged, and time from when the product is packaged to when the packaged product is picked up by the carrier.

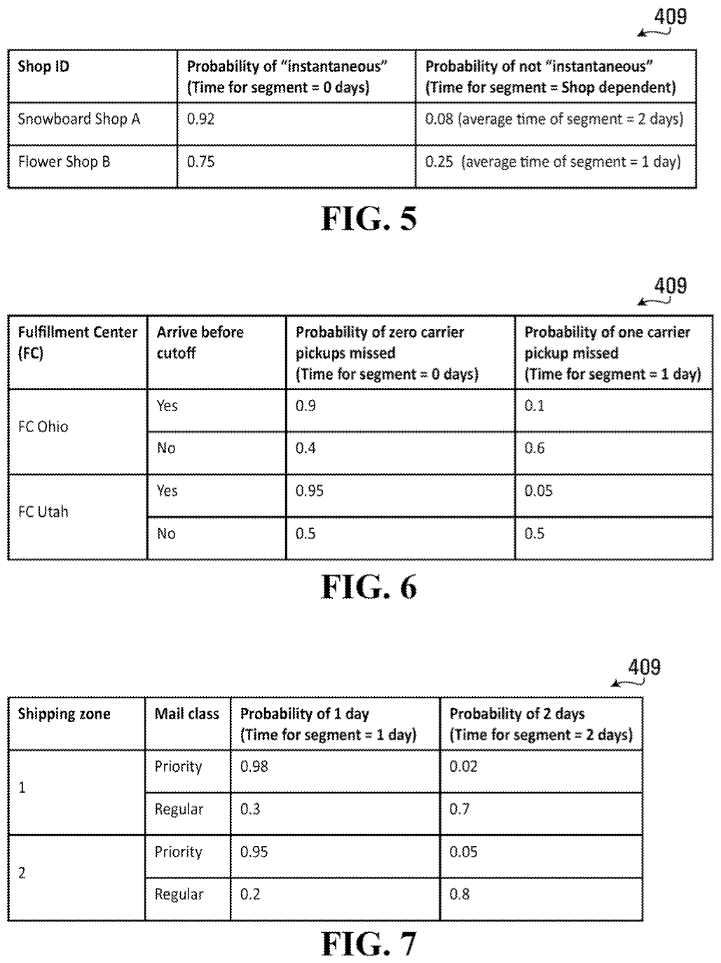

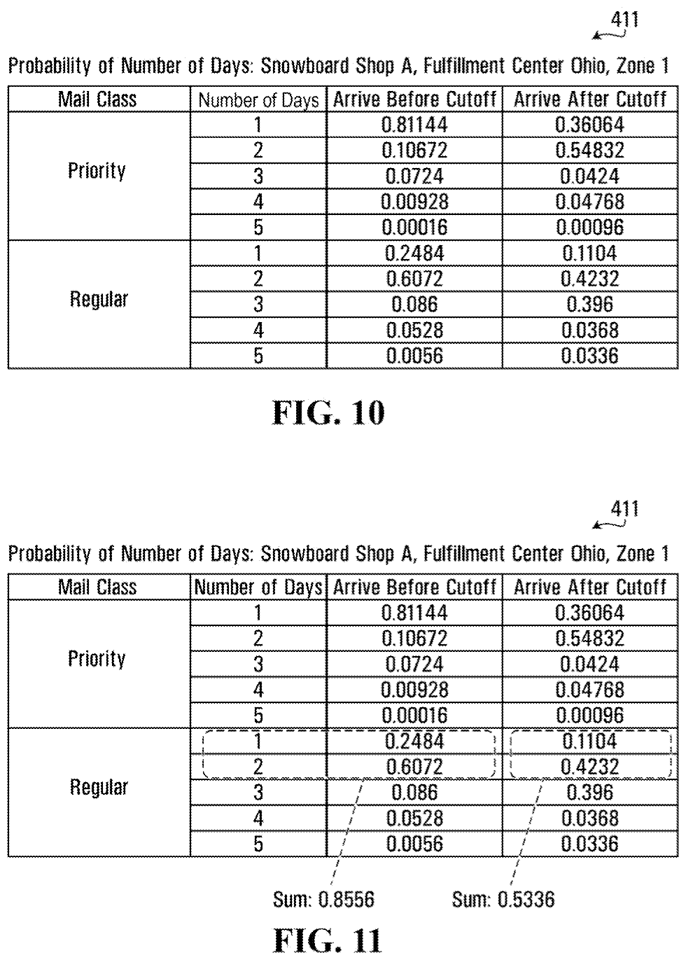

FIGS. 5 to 7 illustrate examples of look up tables (LUTs), each providing segment probabilities for a respective different non-overlapping segment of the delivery timeline, according to some embodiments. The LUTs of FIGS. 5 to 7 may be stored as the delivery timeline segment tables 409 in the memory 408 of the delivery time information generator 402. Each LUT in FIGS. 5 to 7 is an example of an intermediary data structure. The data structure is “intermediary” because, as explained later, the information in each of the intermediary data structures is combined to form a “master” data structure (e.g. FIG. 10), which is used to determine a probability that the product is delivered within a specific product delivery time window.

FIG. 5 illustrates a first LUT representing segment (1) as defined above, i.e. the time from when the order is placed to when a fulfillment center is selected and notified. In this example, the first LUT is generated using historical data and/or the shop's current settings to produce a probability indicating whether segment (1) will take a negligible amount of time to complete. The first column of the LUT of FIG. 5 provides the input. The second and third columns provide probabilities of the time taken for the segment to be completed as “instantaneous” or “not instantaneous”. The term: “Instantaneous” in FIG. 5 does not literally mean instantaneous, but it means it happens quickly enough that it does not impact overall delivery time in a meaningful way, e.g. it takes less than 15 minutes or is acted on in a timeframe before a known cutoff or deadline. If not instantaneous, the average amount of time taken is recorded. The input is an identifier of the online store or marketplace, referred to as Shop ID. In the LUT of FIG. 5, the Shop ID options provided are: “Snowboard Shop A” and “Flower Shop B”. Historical data may show that different shops take different amounts of time for segment (1), which may be dependent upon whether a manual review of the order occurs by the merchant before it can proceed. For example, historical data and/or the shop's current settings have indicated that, for Snowboard Shop A, there is a 92% chance that the duration of time from when an order is placed on the shop to when a fulfillment center is selected and notified is “instantaneous”. There is an 8% chance that the duration of time from when the order is placed to when a fulfillment center is selected and notified is “not instantaneous”, in which case historical data indicates that the average duration of time in that situation is 2 days.

The table of FIG. 5 is simplified for ease of explanation. In actual implementation, the table might have probabilities that are a function of more than just Shop ID, e.g. they may also be a function of the time of day and day of week at which the order was placed, and/or the product ID, etc.

In some embodiments, the first LUT may be generated using historical data in combination with the shop's current settings and/or other data. This may include partner-provided data, such as carrier provided times in transit or fulfillment center schedules. The historical and/or partner provided data may be further combined with future-looking data, such as weather events or periods of expected increases in a volume of packages being shipped.

FIG. 6 illustrates a second LUT representing segment (2) as defined above, i.e. the time from when the fulfillment center is notified (i.e. the order arrives at the fulfillment center) to when the packaged product is picked up by the carrier. The second LUT may be generated using historical data and/or other information (e.g. carrier provided times in transit, and/or fulfillment center schedules, and/or future-looking data, such as weather events, and/or the shop's current settings etc.) to produce a probability of how many carrier pickup intervals are missed between when the fulfillment center is notified to when the packaged product is picked up by the carrier. The carrier pickup times are known in advance and so the number of carrier pickup intervals missed is indicative of the duration of segment (2).

In the LUT of FIG. 6, one of the inputs is the fulfillment center (FC) where the product to be shipped originates. In this example, the FCs provided are “FC Ohio” and “FC Utah”. The other input is a determination as to whether the order arrives prior to a cutoff time. “Cutoff time” refers to the time of day at which an order can arrive at a FC and still typically be picked and packed before a carrier pickup time specific to a particular carrier. For instance, an order may be required to arrive at an FC before 13:00 in order to be ready for a carrier's usual 16:00 pickup later that day. The outputs of FIG. 6 provide (a) the probability that no carrier pickups have been missed, resulting in an estimated elapsed time of segment (2) to be zero days, and (b) the probability that one carrier pickup has been missed, resulting in an estimated elapsed time of segment (2) to be one day.

The table of FIG. 6 is a simplified example, in which there are no additional delays provided by the FCs beyond one missed carrier pickup. In the example, and for simplicity, it is assumed that a product never misses more than one carrier pickup once the FC has been notified. For instance, the FC might have steps in place to ensure that each order may only miss maximum one carrier pickup, resulting in a maximum duration of segment (2) to be one day. In other implementations, the LUT representing segment (2) might include additional columns that include probabilities associated with greater numbers of carrier pickups missed for each order, with each column associated with segment (2) having a duration of a respective number of days. One of the columns may be a “catch-all” column, e.g. probability of two or more missed carrier pickups. The probabilities for each row would be required to have a sum of 1.

In the example, if the order arrives at the fulfillment center before the cutoff time, then there is a high probability that it is picked up by the carrier on the same day, otherwise, it is picked up the next day. The table of FIG. 6 is simplified for ease of explanation. In actual implementation, the table might have probabilities that are a function of more than just fulfillment center and arrival before or after cutoff, e.g. they may also be a function of product ID, shop ID, day of the week (different carriers might have different pickup schedules on weekends), carrier, mail class (different carriers may pick up expedited products more often), etc.

In some implementations, a carrier may have multiple pickup times per day from each fulfillment center. Subsequently, there may be multiple cutoff times per day, each cutoff time corresponding to a respective pickup time, for each carrier at the fulfillment center. In such an implementation, missing a particular carrier pickup, or even a number of carrier pickups depending on the time of day, might not result in an estimated elapsed time of segment (2) to exceed zero days.

FIG. 7 illustrates a third LUT representing segment (3) as defined above, i.e. time from pickup by the carrier to delivery. The third LUT may be generated using historical data and/or other information (e.g. carrier provided times in transit, and/or fulfillment center schedules, and/or future-looking data, such as weather events, etc.) to produce a probability of how many days it takes the carrier to deliver the product after pickup, which is typically at least a function of delivery location (expressed as a shipping zone relative to the fulfillment center) and a combination of the carrier and mail class. Note that delivery location may be interchangeably referred to as destination location.

The LUT of FIG. 7 is simplified for ease of explanation. In actual implementation, the table might have probabilities that are a function of more than just shipping zone and mail carrier + mail class, e.g. they may also be a function of weight/dimension of product, day of week of pickup, country or state of destination, etc. Also, for simplicity, the table of FIG. 7 assumes that a carrier never takes more than 2 days to deliver the product.

In another implementation, the table associated with segment (3) might include additional columns that include probabilities associated with longer delivery times, with each column associated with segment (3) having a respective duration. For instance, there might be columns representing the probability of delivery to each shipping zone via each mail class having a delivery time of 3 day, 4 days, and 5 days. The probabilities for each row would be required to have a sum of 1.

The probabilities computed for each segment (e.g. the probabilities in the LUTs in FIGS. 5 to 7) may each be computed using historical order/delivery information, e.g. by application of a machine learning algorithm to a large set of data associated with previous products that have already been purchased and delivered. To prepare the historical data for processing by the machine learning algorithm, “cleaning” of the data may be required, e.g. to reformat the data into a uniform machine-readable format (e.g. one-hot encoding of the fulfillment center location, etc.). The cleaning of the data may also or instead be performed in order to account for spikes known to occur at certain predetermined dates (e.g., flower delivery on Mother's Day etc.).

In some embodiments, rather than a LUT as described in each of FIGS. 5 to 7, a segment (or portion of a segment) might be assigned an average time, which might or might not be a function of different inputs.

The LUTs of FIGS. 5 to 7 are combined to yield a master LUT expressing probabilities for number of days for delivery for each given set of inputs.

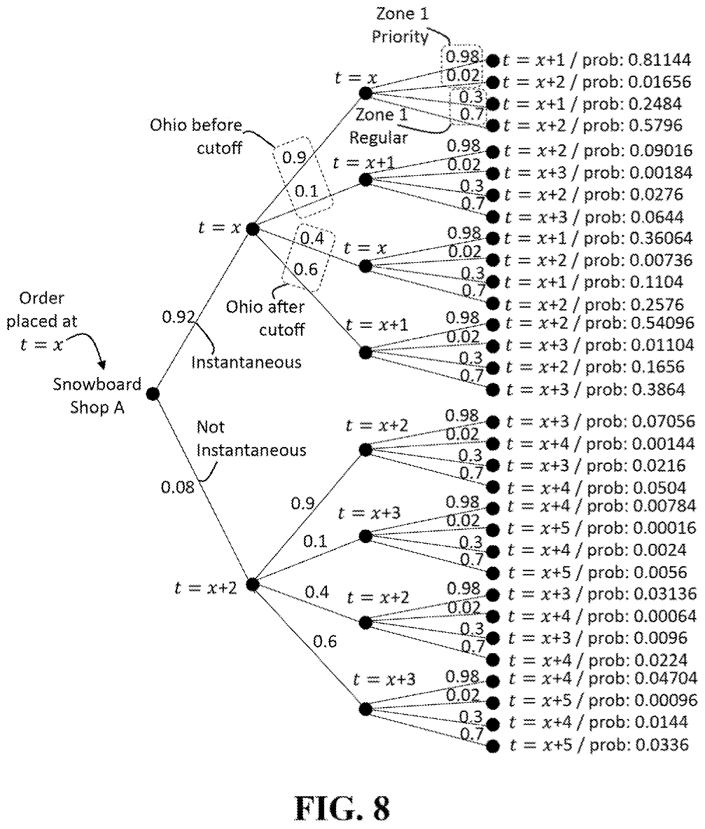

FIG. 8 illustrates a trellis graph illustrating input/output connections between the LUTs of FIGS. 5 to 7, according to one embodiment. The input/output connections of the trellis graph are provided for a specific set of input information relating to the example above: an order is placed at Snowboard Shop A at time x, the fulfillment center is Ohio, and the destination location is in shipping zone 1. In the context of web browsing, the destination location may be inferred from the IP address of the customer device 420 or explicitly provided by the user, the shipping zone may be inferred from the destination location compared to the location of the fulfillment center, the location of the fulfillment center may be inferred from the destination location and the product ID, and the product ID may be identified in the web page request.

In the trellis graph of FIG. 8, the left-most node is indicative of the input to the first LUT in FIG. 5 of segment (1): the Shop ID, which in this example is Snowboard Shop A. The node branches out based on the two possible outputs of the first LUT for Snowboard Shop A: the upper branch, in which the FC is selected and notified instantaneously after the order is placed; and, the lower branch, in which the FC is not selected and notified instantaneously after the order is placed. Each of these branches include labels having the probability of the given outcome occurring, and the secondary nodes at the end of each branch indicate the expected time at the end of segment (1). Each of these secondary nodes then branches out based on the input/outputs of the LUT representing segment (2) FC Ohio of FIG. 6 to tertiary nodes, and then the tertiary nodes each branch out based on the input/outputs of the LUT representing segment (3) shipping zone 1 of FIG. 7.

The trellis graph of FIG. 8 may be converted into a master LUT expressing the probability of number of days for delivery relative to order time x. As the order has not yet been placed, the order time x may be assumed to be the time at which the delivery time information is being generated or shortly thereafter (e.g. on the assumption that the order will be placed in the near future). This is shown in the trellis graph of FIG. 8, in which a label above the left-most node, indicating the input to the first LUT for segment (1), provides: “Order placed at t=x”. Each of the secondary, tertiary, and end nodes of the trellis graph have an associated time label, in which the time label provides t to be the sum of x and the expected number of days required to reach the point in the delivery timeline indicated by the node.

In some embodiments, delivery time information (such as a delivery promise) may be presented with a particular expiration date or time. For instance, a delivery promise may be presented with the caveat: “Order within 10 minutes for guaranteed delivery in 2 days”. In such an embodiment, the assumed order time x is limited to the presented particular expiration date or time (e.g. x is limited to 10 minutes into the future).

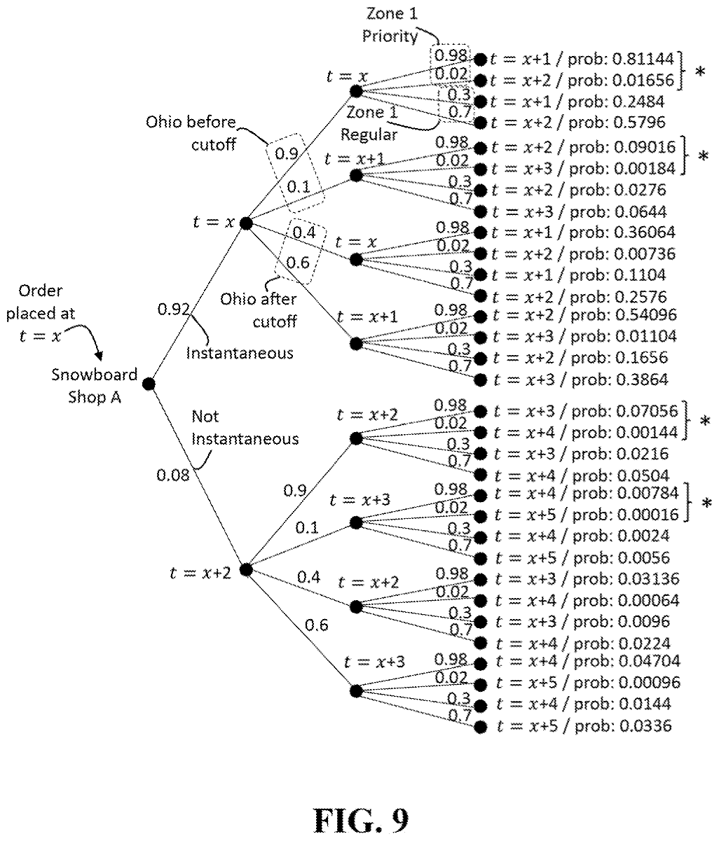

FIG. 9 illustrates the trellis graph of FIG. 8, but identifies, using an asterisk (*), the probability of number of days to delivery assuming cutoff time in the fulfillment center is met and mail class is priority shipping. Probabilities can be added together to determine the probability of certain scenarios (e.g. delivery in a certain number of days).

For instance, in the trellis graph of FIG. 9, the asterisks represent the probabilities associated with the order placed at Snowboard Shop A at time x, the fulfillment center being in Ohio, the destination location being in shipping zone 1, and priority shipping. From the top of the diagram, the first asterisk represents the probability of the order arriving at x+1 day and x+2 days assuming: “instantaneous” selection and notification of the FC after the order is placed in Snowboard Shop A, the order arrives at the Ohio FC before the cutoff, the carrier pickup is not missed, and the product is shipped to shipping zone 1 using the “Priority” mail class. The sum of the probabilities encompassed by the first asterisk is 0.81144+0.01656=0.828, indicating that there is 0.828 likelihood that the product is delivered within 2 days if the carrier pickup is not missed.

The second asterisk from the top represents the probability of the order arriving at x+2 days and x+3 days assuming: “instantaneous” selection and notification of the FC after the order is placed in Snowboard Shop A, the order arrives at the Ohio FC before the cutoff, the carrier pickup is missed, and the product is shipped to shipping zone 1 using the “Priority” mail class. The sum of the probabilities encompassed by the second asterisk is 0.09016+0.00184=0.092, indicating the likelihood that, when the carrier pickup is missed, the order arrives in 2 or 3 days.

To determine, for example, the probability that delivery happens in exactly 2 days assuming Snowboard Shop A, Ohio FC, and Shipping Zone 1, the probabilities for x+2 days are added for those given set of inputs. For example, the probability of delivery of exactly 2 days when there is arrival before cutoff and priority shipping is 0.01656+0.09016=0.10672. Whereas, the probability of delivery of exactly 2 days when there is arrival before cutoff and regular shipping is 0.5796+0.0276=0.6072.

FIG. 10 illustrates a master LUT generated from the trellis graph of FIG. 8, according to one embodiment. FIG. 11 is the same master LUT of FIG. 10, but highlighting certain probabilities referenced later. The master LUT of FIG. 10 may be an example of the master delivery timeline table 411 stored in the memory 408 of the delivery time information generator 402. An equivalent master LUT (or LUT entries of a master LUT) is also generated for every other possible combination of inputs. For example, another version of the LUT of FIG. 10 exists for shipping zone 2, corresponding versions exist for fulfillment center Utah, corresponding versions exist for Flower Shop B, etc.

In some implementations, the master LUT of FIG. 10 may be an excerpt of the master delivery timeline table 411.

The master LUT of FIG. 10 is specific to Snowboard Shop A, FC Ohio, and delivery location in Zone 1. It stores the probability that delivery takes a particular number of days for each mail class and dependent upon whether the order arrives at the FC before or after cutoff. For example, the probability of delivery of exactly 2 days when there is priority shipping and arrival or the order before cutoff is 0.10672. The value 0.10672 is computed as explained above using the trellis graph in FIGS. 8/9: 0.01656+0.09016=0.10672.

The master LUT of FIG. 10 may be generated offline, and then subsequently used during web browsing to generate delivery time information more quickly, thereby reducing complexity during web browsing because the full computation does not have to be performed in real-time, rather the master LUT of FIG. 10 may be used. For example, at 08:00, a user requests a product page for a product via the customer device 420 (e.g. using a HTTP or HTTPS request). Based on the data in the request, the computer, such as the delivery time information generator 402, determines: the product ID (e.g. based on the requested URL), the shop ID (e.g. based on the requested URL), the destination location (e.g. inferred from the IP address of the customer device 420 or explicitly provided by user), the fulfillment center (e.g. inferred from product ID and destination location), and the shipping zone (e.g. inferred from distance between fulfillment center and destination location). An order time of 08:00 is assumed, from which the time at which the order arrives at the fulfillment center is estimated (e.g. using the LUT of FIG. 5) and compared to the cutoff time at which the order needs to arrive at the FC to be typically processed and sent out by the carrier same day. Assuming it is before the cutoff time, and assuming regular mail class, the LUT of FIG. 10 reveals that there is an 85.56% chance of a delivery within 2 days, as shown in FIG. 11. If the order arrives after the cutoff, then the probability drops to 53.36%. If it happened to be the case that on average the cut off time is missed only 10% of the time, then the expected probability of meeting a two-day delivery promise using regular mail class becomes 82.34% (i.e., 0.9×85.56%+0.1×53.36%). In response, delivery within 2 days may be indicated in the web content of the product page (e.g. as a delivery promise). Alternatively, multiple delivery promises may be shown to the buyer (e.g. 1-day, 2-day, 3-day), potentially with respective prices given for each, e.g. if the buyer has the option to pay a fee for priority mail class to ensure faster delivery.

The probability obtained using the LUT of FIG. 10 may form the input of one or more rules for displaying information, e.g. selecting among possible delivery promises, in generated web content. An example rule might be: If probability of delivery within 3 days is greater than 95%, then promise delivery within 3 days. Rules may be global (e.g. across all merchants) or possibly configured by a merchant, e.g. on a merchant-by-merchant, shop-by-shop, and/or product-by-product basis.

In some embodiments, there may be rules configured around delivery promises, e.g. if a business decision has been made to provide a certain number of delivery promises to customers. For example, a target may be to promise delivery within 2 days on Z % of orders, where Z may be globally set or configured by the merchant. One example rule incorporating such a constraint might be as follows:

(a) Y is the percentage of the last 500 orders for which a delivery promise was made, and X is a minimum threshold (e.g. X=1%)

(b) If X≤Y<Z, and if 90%+ probability that regular mail class would deliver the order within 2 days, then promise delivery within 2 days.

(c) IF Y<X, and if 90%+ probability that priority mail class would deliver order within 2 days, THEN promise delivery within 2 days and use priority mail class.

In some embodiments, the constraints may also or instead be based on the accuracy of the delivery promises (e.g. the promised number of days to delivery of a product provided to a customer is reliable), and/or the cost of enabling the delivery promises provided (e.g., based on a budget), and/or a number of promises shown to customers. For example, one rule may involve showing as many promises as possible to customers that have an accuracy of 80%, such that enabling the promises fits within a budget of $10,000 per week.

The rule(s) may depend upon budgets configured globally or by the merchant, e.g. the merchant is willing to pay $10,000 per year on priority mail class to meet target delivery promises, and once the $10,000 is spent the target for delivery promises is no longer required to be met.

In some embodiments, providing delivery promises for a product to the customer device 420 may be based on forecasting a next set of orders. For example, whether or not a delivery promise is included in the web content may be dependent upon what or how many orders are expected in the near future and whether or not they will be good candidates for delivery promises.

In some embodiments, there may be a process to determine if the delivery time information generator 402 is to provide a delivery promise to the customer via the customer device 420 based on a known set of historical orders. For instance, a ranked promising approach may be used to determine for which orders a delivery promise may be provided if there are both accuracy and budget constraints provided.

As an example, a particular order may have an order delivery time accuracy exceeding 80% when shipped using the priority shipping class. However, the product in the particular order might be significantly more expensive to upgrade to the priority shipping class compared to another order that might not have been provided a delivery promise.

In such situations, a ranked promising approach might be used to optimize the assignment of delivery promises. The ranked promising approach may include obtaining order data from a known set of historical orders and cleansing the data to filter out anomalies (e.g., periods of time with a high expected volume of orders, subscriptions, wholesale orders, extreme weather events, etc.). The delivery time information generator 402 may determine which of the orders of the cleansed set of historical orders would have been the most cost-effective to provide delivery promises to meet the constraints, and then rank the orders by cost-effectiveness. The ranking of the orders of the historical ranked data set may then be used to assess whether or not to provide a delivery promise for new orders.

In some embodiments, an optimization model may be used to determine when to present a delivery promise to a customer. The optimization model may be designed with a goal of optimizing a particular metric, such as the total profit for merchants of an e-commerce platform, which is based on the expected conversion and life-time value each type of delivery promise yield.

In some implementations, the delivery time information generator 402 may receive a batch of new orders to consider as a group. For instance, a group may consist of any orders that are to be submitted overnight, and/or any orders arriving after carrier pickup and before the next cutoff time for the FC in relation to that carrier, etc.

In some embodiments, the computer at a fulfillment center or in a fulfillment network may verify or override delivery time information (e.g. a delivery promise) prior to the delivery time information being transmitted to the user device, e.g. based on constraints not incorporated into the model used to generate the delivery information. For example, the fulfillment center might be aware of a temporary local constraint (e.g. backlog) that would prevent timely processing of the order.

In some embodiments, the use of the delivery time information generator 402 may improve an experience of a customer browsing or shopping online. By providing the delivery time information in real time as the customer is requesting/interacting with the web content, the customer may be incentivized to purchase the product based on the knowledge of when the arrival of the product is to be expected. The use of the delivery time information generator 402 may increase the accuracy of the delivery time information provided to the customer in a real time application, which allows for more reliable estimates of delivery times and subsequently better customer service. Additionally, a technical benefit of some embodiments may include improved accuracy and computation of an estimated delivery time probability through the use of the intermediary data structures (e.g. the LUTs in FIGS. 5 to 7), with each intermediary data structure corresponding to a respective different time segment of the delivery process. This is because the probability of each segment having a particular time duration can be computed for that segment using the input factors that are specifically relevant to that segment. For example, the input factors considered for the LUT in FIG. 6 are FC and arrival before or after cutoff, whereas the input factors considered for the LUT in FIG. 7 are shipping zone and mail class. Each LUT may have a reduced set of input factors that are specific to that segment. The reduced set of input factors may allow for less complexity (fewer input factors for a segment) and more accuracy (input factors most important to that segment). Another technical benefit of some embodiments is the ability to provide the delivery time information in real-time between when a request for web content is received and when the web content is returned to the customer device, e.g. because of the data structure (such as that in FIG. 10) having the probabilities precomputed for different sets of input factors. The precomputed probabilities (e.g. in FIG. 10) can be referenced during browsing in real-time, rather than computed from scratch during the time between when the web content is requested and when the web content is returned.

### Example User Interfaces

The delivery time information related to a product may be provided to the customer via the customer device 420 while either browsing an online store or marketplace, or making a purchase online. The delivery time information, such as a delivery promise, is shown to the customer in real-time, which may influence the customer's decision to purchase the product.

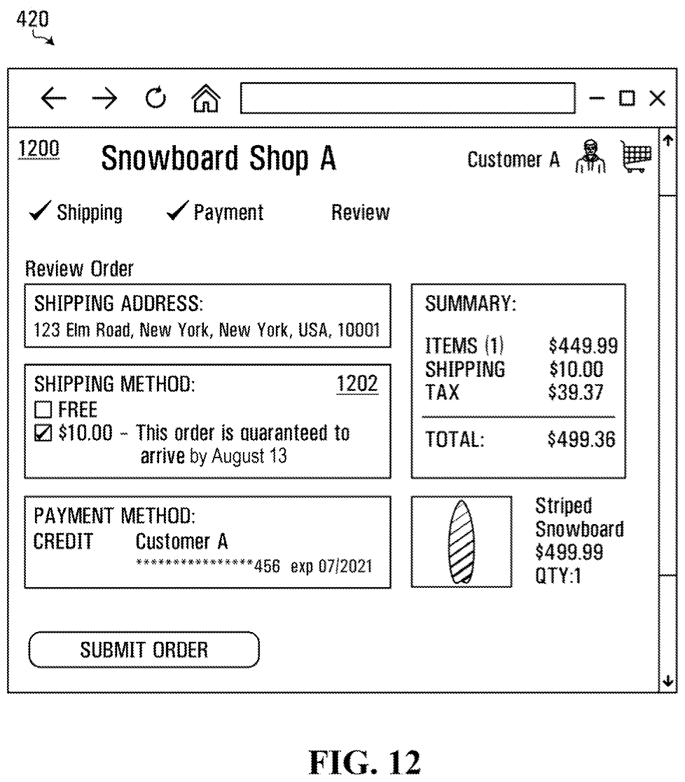

FIG. 12 illustrates an example of a user interface for displaying the information relating to the delivery time of a product on a checkout page, according to one embodiment. The checkout page 1200 may be transmitted to the customer device 420 to be provided to the customer via the user interface 428 of the customer device 420. The checkout page 1200 may be provided to the customer during the purchasing of one or more products for sale in an online store or an online marketplace. Here, the customer is using the customer device 420 to purchase the product: “Striped Snowboard” from “Snowboard Shop A”.

In the checkout page 1200 of FIG. 12, there is web content 1202 allowing the customer to select the shipping method. The web content 1202 provides the customer device 420 with the message: “This order is guaranteed to arrive by August 13”, although it will require a delivery fee to be paid by the customer. In this example, the delivery promise is provided on August 11. Alternatively, the promise might be provided even if free shipping is selected, e.g. if the delivery time information determined by the delivery time information generator 402 reveals a high probability of delivery within 2 days regardless of whether the merchant pays the carrier for priority mail class. At this stage in the checkout process, the customer might have previously provided their shipping information. When the customer device 420 requests the checkout page 1200, the delivery time information generator 402 uses the shipping information (e.g. delivery location) to determine at least one of the inputs to the master delivery timeline table 411. The delivery time information generator 402 extracts the delivery time probabilities associated with the known inputs, and the delivery time promise provided to the customer device 420 may be based on these probabilities. Alternatively, during the real-time checkout process, upon the user entering their shipping information (e.g. shipping address), in response the checkout page 1200 immediately updates to display the delivery promise. The updating happens promptly in the context of web browsing because the delivery time information generator 402 is able to extract the probability of delivery within 2 days from the master delivery timeline table 411 (e.g. in FIG. 10) using the shipping zone derived from the shipping address. Computation of the master delivery timeline table 411 (e.g. in FIG. 10) has previously happened offline, i.e. it does not need to be computed from scratch in real-time to generate the delivery promise.

The checkout page 1200 of FIG. 12 incorporating the delivery time information relating to the product is only an example of a user interface that includes a delivery promise, and is not intended to be limiting. The display of delivery time information on a checkout page shown on a customer device can appear in any form.

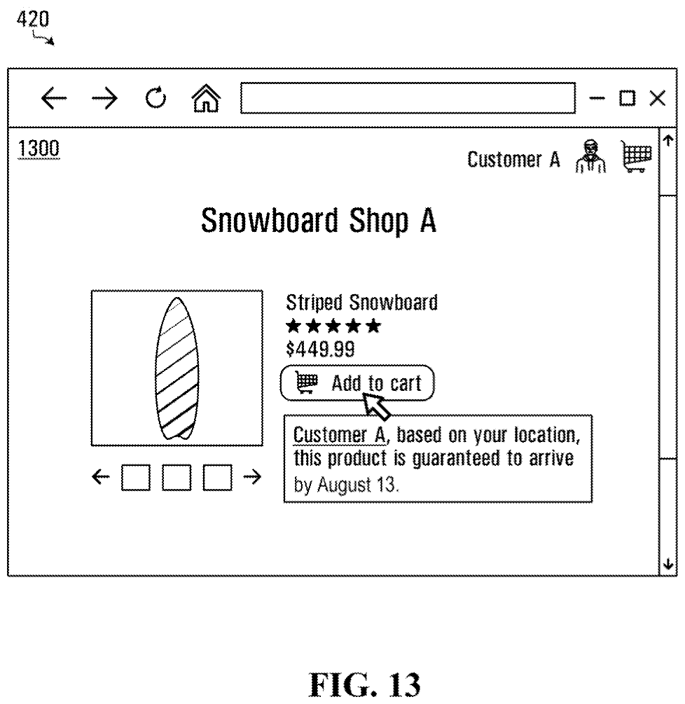

FIG. 13 illustrates an example of a user interface for displaying the information relating to the delivery time of a product on a product page, according to one embodiment. The product page 1300 may be provided to the customer via the user interface 428 of the customer device 420. For example, the product page 1300 in FIG. 13 is the product page for the product: “Striped Snowboard” in an online store for “Snowboard Shop A”. In this example, the product page 1300 is provided on August 11, and the following message is provided: “Customer A, based on your location, this product is guaranteed to arrive by August 13”. In an alternative implementation, the message provided may provide: “Customer A, based on your location, this product is guaranteed to arrive within 2 days”.

When the customer device 420 sends a request (e.g. HTTP or HTTPS request) to load this product page 1300, a request for delivery time information may be sent over a network to the delivery time information generator 402. The processor 404 of the delivery time information generator 402 may then determine the delivery time information based on the probabilities extracted from the master delivery timeline table 411, as described herein. If the probability of a delivery time extracted from the master delivery timeline table 411 falls within a particular confidence interval, the delivery time information generator 402 may reply to the request by providing the delivery time information to the customer device 420 as part of the product page 1300.

The product page 1300 of FIG. 13 incorporating the delivery time information relating to the product is only an example of a user interface that includes a delivery promise, and is not intended to be limiting. The display of delivery time information on a product page shown on a customer device can appear in any form.

In some embodiments, the delivery time information may be incorporated into the regular text matter on the product page 1300. Alternatively, the delivery time information may appear based on an interaction with the product page 1300, such as hovering the cursor over the “Add to cart” button, or clicking on a button requesting the delivery time information.

In some implementations, the request for the web content (e.g. product page or checkout page) may include information specific to the customer and/or the customer device 420. For instance, in FIG. 1300, the customer is signed into an account with the online store/marketplace. The account might save information associated with the customer, such as the customer's shipping address. Therefore, the request sent to the delivery time information generator 402 may include customer's address, which may be used as one of the inputs to the master delivery timeline table 411, or used to determine an input to the master delivery timeline table 411. For example, Customer A may have a shipping address in New York City, USA associated with their account. The delivery time information generator 402 may determine that New York City, USA falls within the limits of shipping zone 1 relative to the FC, and therefore may indicate (and/or use) the appropriate portion of a master LUT, such as the master delivery timeline table 411 of FIGS. 10 and 11, which is relevant to determining a delivery time for the product.

In some implementations, the request for the product page 1300 may include information relating to the customer's shipping location to determine a delivery time for the product based on the location of the customer device 420. For example, the IP address of the customer device 420 may be used to infer the delivery location. As another example, the customer's geolocation may be approximated based on GPS location or location of the network that the customer device 420 is connected to. This information may be provided to the delivery time information generator 402 as an input, or to determine an input, to the data structure used to determine delivery time information.

In some implementations, the product page 1300 may include a field for the customer to enter shipping address information, such that the delivery time information generator 402 is able to determine the shipping zone and/or other inputs associated with the customer to be used to determine shipping time information.

In some embodiments, the delivery promise may be provided to the customer prior to or following the purchase of an item from the online shop, and the delivery promise may be communicated to the customer afterwards via, for example, a purchase confirmation email.

In some embodiments, the delivery promise described above may be a preliminary delivery promise provided to the customer before or during the purchase of the product from the online store. A secondary delivery promise may be provided to the customer following the purchase of the product, for example, in a purchase confirmation email. The secondary delivery promise may be a revised version of the preliminary promise based on the inclusion of new or updated information, such as weather or traffic reports.

### Example Methods

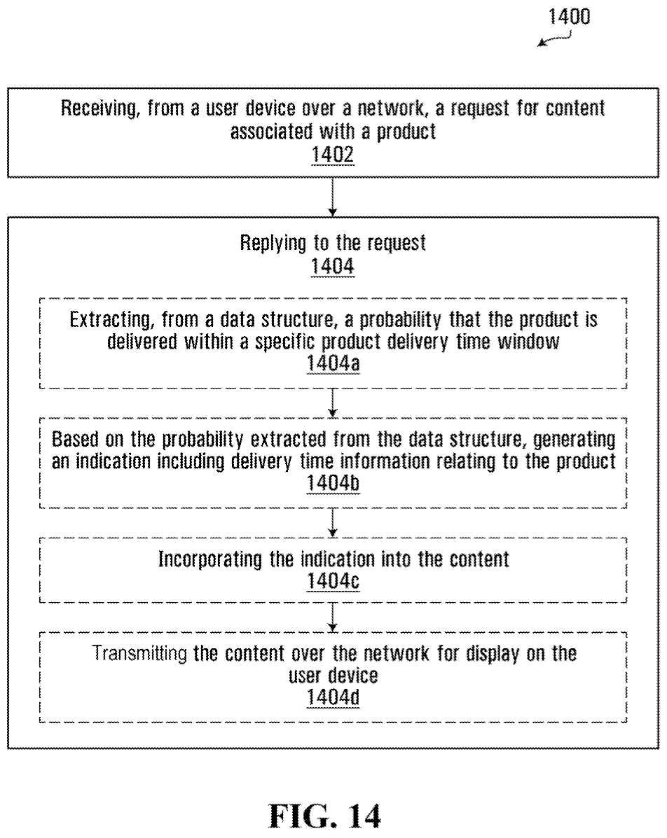

FIG. 14 illustrates a computer-implemented method 1400, according to one embodiment. Not all of the steps in the method 1400 of FIG. 14 are necessary in all embodiments. Also, some of the steps may be substituted by other steps instead. The method may be performed by or on an e-commerce platform, such as e-commerce platform 100 of FIG. 1, although this is not necessary. In method 1400, the steps are described as being performed by the processor 404 of delivery time information generator 402 of FIG. 4, but this is only an example. For example, the method 1400 may instead be performed by another entity, which might or might not be part of an e-commerce platform. In one alternative example, some of the steps of the method 1400 may be performed by an entity separate from the delivery time information generator 402. For example, receiving and/or responding to a request for content relating to a product may be performed by another entity (e.g. another processor) separate from the delivery time information generator 402 itself. The delivery time information generator 402 might be limited to just extracting a probability that the product is delivered within a specific product delivery time window from a data structure.

At step 1402, the processor 404 receives, from a user device over a network, a request for content associated with a product. The user device may be customer device 420 and may communicate with the delivery time information generator 402 over a network via their respective network interfaces 426 and 406. For instance, a customer may request content, such as a product page for a product in an online store, via the user interface 428 of the customer device 420. An example of this may be a customer using their customer device 420 to open the product page for the “Striped Snowboard” in the online store associated with “Snowboard Shop A”. The request may be sent through network interface 426 and received at network interface 406.

Step 1404 includes replying to the request. The replying to the request is performed by the processor 404 of the delivery time information generator 402.

Step 1404 includes the step 1404a of extracting, from a data structure, a probability that the product is delivered within a specific product delivery timeline window. The data structure may be the master delivery timeline table 411 stored in the memory of the delivery time information generator 402, and may be embodied, for instance, as the LUT of FIGS. 10 and 11. Step 1404a may include partitioning a delivery timeline of the product into non-overlapping segments. For each segment of the non-overlapping segments, the method 1400 may include computing segment probabilities, wherein at least two of the segment probabilities are each associated with a respective different time duration for completing the segment. Step 1404a may also include combining the segment probabilities of the segments to form the data structure, such that an output obtainable from the data structure includes a plurality of probabilities and each of the plurality of probabilities corresponding to a respective different product delivery time window.

In some implementations, the segment probabilities may include at least a first probability that the segment will have a first time duration and a second probability that the segment will have a second time duration. For example, the segment probabilities in FIG. 6 include 0.9 and 0.1. The 0.9 is the probability that the segment will have a duration of zero days (assuming FC Ohio and arrive before cutoff). The 0.1 is the probability that the segment will have a duration of one day (assuming FC Ohio and arrive before cutoff).

For example, the delivery timeline of shipping the “Striped Snowboard” to a customer in New York City may be partitioned into three non-overlapping segments: (1) time from when the order is placed to when a fulfillment center is selected and notified; (2) time from when the fulfillment center is notified to when the packaged product is picked up by the carrier; and, (3) time from pickup by the carrier to delivery.

In this example, for each of segments (1), (2), and (3), the segment probabilities for each segment are computed. These individual segment probability computations may be provided by the delivery timeline segment tables 409 stored in the memory 408 of the delivery time information generator 402. The delivery timeline segment tables 409 of (1), (2), and (3) may be provided as the LUTs of FIGS. 5, 6, and 7, respectively. The output columns of the LUTs in each of FIGS. 5, 6, and 7 may include probabilities associated with different time durations required to complete the segment. For instance, in FIG. 5, the probability that segment (1) is completed within zero days is shown to be 0.92 and the probability that segment (1) is completed in two days is shown to be 0.08 for Snowboard Shop A.

The combining the segment probabilities of the segments to form the data structure may include combining the delivery timeline segment tables 409 to provide the master delivery timeline table 411, such as the LUT in FIG. 10. In the LUT of FIG. 10, the output probabilities each correspond to a number of days required for the delivery shown in the second column of the table. For instance, the probability that the product arrives in one day is 0.81144 if the product is shipped using the “Priority” mail class and arrives at the FC before the cutoff time.

Step 1404 may also include step 1404b, which may involve generating an indication including delivery time information relating to the product based on the probability extracted from the data structure. The processor 404 of the delivery time information generator 402 may generate the indication based on the probability outputs of the master delivery timeline table 411. The indication may be a message, e.g. a message included as part of the content.

For example, the processor 404 may generate an indication that the “Striped Snowboard” may be delivered to the customer in New York City within 2 days of ordering the product based on the output probabilities of the master LUT in FIGS. 10 and 11. If the product is shipped using the “Regular” mail class, there is a probability of 0.8556 that the product will be delivered in 1 or 2 days if the order arrives before the cutoff, and a probability of 0.5336 if the order arrives after the cutoff. As well, there is a greater probability that the product arrives within 2 days if shipped using the “Priority” mail class. Rules stored in the memory 408 may determine that there is a high enough confidence level to provide an indication that the product will be delivered in less than or equal to 2 days.

At step 1404c, the processor 404 may incorporate the indication in the content. Here, the delivery time information generator 402 may prepare the content, such as the product page for the “Striped Snowboard” to include the indication having the delivery time information relating to the product. For example, the processor 404 may prepare the product page to include an indication that the product may or will be delivered to the customer within 2 days.

Step 1404d may include transmitting the content over the network for display on the user device. This may include the processor 404 of the delivery time information generator 402 instructing transmission of the content having the indication by instructing the network interface to send the content to the customer device 420 (e.g. as a response to an HTTP or HTTPS request for the content). For example, the product page 1300 of the “Striped Snowboard” may be transmitted to the customer device 420 and presented to the user via the user interface 428 of the customer device 420, as shown in FIG. 13. The product page 1300 may include the indication as a message, for instance, the following message in FIG. 13: “Customer A, based on your location, this product is guaranteed to arrive by August 13”.

In some embodiments, the probability extracted from the data structure is extracted based on the data in the request. For example, a customer using a customer device 420 may request the product page for the “Striped Snowboard” in the online store for “Snowboard Shop A”. In one example, the request may explicitly include data required to determine which probability to extract, e.g. the request may include an IP address of the customer device 420 (used to infer delivery location) and the URL of the product page (used to determine Shop ID and Product ID). The fulfillment center may then be inferred from product ID and delivery location, and the shipping zone may be inferred from the distance between the inferred fulfillment center and the inferred delivery location. Then, based on the known or inferred information, which act as inputs to the data structure, the appropriate probability is extracted from the data structure (e.g. 0.8556 probability of delivery within 2 days for Snowboard Shop A, FC Ohio, Shipping Zone 1, and assuming regular shipping and arrival of order at FC before cutoff, as shown in FIG. 11). In another example, the request may include information such as the shipping address of customer A, which, based on historical information and/or other information, may provide other inputs such as the fulfillment center and the shipping zone. The processor 404 of the delivery time information generator 402 may use these inputs to extract the probability from the data structure to determine the information relating to the delivery time of the product. For instance, the inputs may inform the relevant regions of the master delivery timeline table 411 from which a probability is extracted, such as the data shown in the master delivery timeline table of FIG. 10.

In some embodiments, in which step 1404a includes partitioning a delivery timeline of the product into non-overlapping segments, the partitioning may include configuring a plurality of intermediary data structures. Each one of the intermediary data structures may correspond to a respective non-overlapping segment of the delivery timeline, and each one of the intermediary data structures may provide an output based on a respective set of inputs, in which the output is the segment probabilities for the respective non-overlapping segment. The processor 404 of the delivery time information generator 402 may generate the delivery timeline segment tables 409 stored in the memory 408 based on each non-overlapping segment as the intermediary data structures.

For example, in determining the information relating to the delivery of the “Striped Snowboard”, the delivery timeline is partitioned into segments (1), (2), and (3) described above. An intermediary data structure for each of these segments may be configured as the LUTs of FIGS. 5, 6, and 7, respectively. The table of FIG. 6 may represent non-overlapping segment (2) of the delivery timeline, which is the time from when the fulfillment center is notified to when the packaged product is picked up by the carrier. The set of inputs to table of FIG. 6 are the selected fulfillment center from which the product is shipped, and an indication as to whether the order arrives before the cutoff time. The outputs of the table of FIG. 6 are the probability of the order is fulfilled in time to be picked up by the carrier that day (resulting in zero additional days added to the delivery time), and the probability that the order fulfillment was not completed in time to be picked up by the carrier (resulting in one additional day added to the delivery time).

In some implementations, the set of inputs for a particular intermediary data structure includes at least one of: a shop identifier; a time at which an order is placed; a shipping zone associated with a delivery location (e.g. a shipping zone of a customer associated with the user device); a carrier; a mail class (also sometimes called a shipping class); or, a particular fulfillment center.

In some implementations, an output for an intermediary data structure corresponding to a non-overlapping segment may be used to determine whether to include a delivery time of the product as part of the content (e.g. as part of an indication including the delivery time information). For example, if a LUT associated with segment (1) stores a high probability that the shop associated with the shop ID does not instantaneously accept the order and provide a notification to the fulfillment center, the delivery time information generator 402 might not provide delivery time information as part of the content provided to the customer via the customer device 420.

In some embodiments, the combining the segment probabilities may include multiplying an intermediary data structure probability output by one intermediary data structure with a corresponding intermediary data structure probability output by one or more or each of the other intermediary data structures. As the probabilities of each segment cascade to the next segment of the delivery timeline, determining a probability that multiple events have occurred requires multiplying together respective probabilities representative of each event. This is illustrated via the trellis graph in FIG. 8 and FIG. 9.

For example, in FIG. 8, the probability that the product is delivered in one day if the “Striped Snowboard” is sold via “Snowboard Shop A” and immediately notifies the FC, is shipped via the FC in Ohio and order arrives before the cutoff, and is shipped to an address in shipping zone 1 using the “priority” mail class is 0.81144. This probability can be determined by multiplying the corresponding segment probabilities provided in the delivery timeline segment tables 409 of FIGS. 5, 6, and 7. The segment probability of “instantaneous” notification by Snowboard Shop A is 0.92, as shown in the intermediary data structure representing segment (1) in FIG. 5. Then, the segment probability of zero carrier pickups missed if the product is shipped via the Ohio FC and the order arrives before the cutoff is 0.9, as shown in the intermediary data structure representing segment (2) in FIG. 6. Lastly, the segment probability of 1 day delivery time in shipping zone 1 using “priority” mail class is 0.98, as shown in the intermediary data structure representing segment (3) in FIG. 7. Multiplying the segment probabilities together yields: 0.92*0.9*0.98=0.81144, which corresponds to the probability provided in the trellis graph of FIG. 8.

In some embodiments, the respective set of inputs of one of the intermediary data structures may be different from the respective set of inputs of another of the intermediary data structures. In some embodiments, the inputs to the data structure may include a union of all of the inputs to the intermediary data structures.

For instance, the delivery timeline segment tables 409 of FIGS. 5, 6, and 7 each may include different inputs. The inputs to the first LUT of FIG. 5 include the Shop ID, as the Shop ID is the main determinant as to whether or not the notification of the order will be sent to the FC instantaneously in segment (1). The inputs to second LUT of FIG. 6 include the FC and an indication as to whether or not the order arrives before a cutoff time, as these are the determining factors whether the product will be packed and prepared for a daily pick up by the carrier in segment (2). Lastly, the inputs to the third LUT of FIG. 7 include the shipping zone and the mail class, which are used to determine the speed of the delivery from the FC to the purchaser in segment (3). The inputs to the master delivery timeline table 411 include a union of all of the inputs to the delivery timeline segment tables 409 of FIGS. 5, 6, and 7. The master delivery timeline table 411 of FIG. 10 provides the probabilities of the number of days required for the delivery of the product based on the inputs: the shop ID, the FC, the indication as to whether the order will arrive at the FC before the cutoff, the shipping zone, and the mail class.

In some embodiments, generation of the indication and/or inclusion of a delivery time of the product as part of the indication may be determined based on the probability extracted from the data structure being within a particular confidence interval (e.g. the probability being above a certain threshold, such as above 80%). For instance, the delivery time information generator 402 may only provide an indication including a delivery time guarantee if the probability of delivery within a particular number of days exceeds a predetermined threshold. In the example of the “Striped Snowboard”, the guaranteed delivery time of 2 days is provided to the customer via the customer device 420 as part of the checkout page 1200 or the product page 1300 because the probability of delivering the product within that time frame is at least 80% based on the known inputs.

In some implementations, generation of the indication and/or inclusion of a delivery time of the product as part of the indication is determined based on one or more of the probabilities corresponding to the respective different product delivery time window segments being within a particular confidence interval.

In some embodiments, the segment probabilities for each non-overlapping segment may be computed based on historical time duration data. Historical data relating to the shipment of other products may be stored in the memory 408 of the delivery time information generator 402, and may be used in order to determine the probability of the number of days each segment may take based on this data. For instance, Snowboard Shop A may automatically send notification to the FC when an order has been placed (e.g., the probability of “instantaneous” notification being 0.92 in FIG. 5). However, during a sale that limits the number of purchases per customer, Snowboard Shop A may manually review orders before notifying the FC to ensure that customers are not abusing the rules in place (e.g., the probability that notification is not “instantaneous” is 0.08). The historical data may include an indication that Snowboard Shop A usually automates order notifications to the FC, resulting in the high “instantaneous” probability.

In some embodiments, generation of the indication and/or inclusion of a delivery time of the product as part of the indication may be determined based on a number of previously provided product delivery times being within a particular range. For example, the delivery time information generator 402 may have constraints such that a particular number of delivery promises are to be provided to customers browsing or making purchases electronically. There may be a rule configured such that the delivery time information generator is to promise delivery within 2 days on Z % of orders. If it is determined that there is a high probability of delivery time of a product being within 2 days, the delivery promise may be provided within the content to the customer device 420, but only if the number of orders provided with promises does not exceed Z %. For instance, if Z is 25% and if a delivery promise was made in 50% of the last 500 orders, then the returned content might not include an indication having a delivery promise, even if there is a high probability that the delivery promise would be met. On the other hand, if hardly any delivery promises have been made in the last 500 orders, then a delivery promise may be made even if it would require priority mail class to ensure a high probability that the delivery promise is met.

In some embodiments, the non-overlapping segments correspond to partitions in time including at least one of: a time an order is placed to a time a fulfillment center is selected and notified; the time the order is placed to a time the order is received at a fulfillment network; the time the order is received at the fulfillment network to the time the fulfillment network selects and notifies the fulfillment center; the time the fulfillment center is notified to a time when a packaged product is picked up by a carrier; the time the fulfillment center is notified to a time the product is picked and packaged; the time the product is picked and packaged to the time when the packaged product is picked up by the carrier; or, the time the product is picked up by the carrier to a time when the product is delivered.

In an example, the delivery of the “Striped Snowboard” is partitioned into three distinct non-overlapping segments: (1) time from when the order is placed to when a fulfillment center is selected and notified; (2) time from when the fulfillment center is notified to when the packaged product is picked up by the carrier; and, (3) time from pickup by the carrier to delivery.

In some embodiments, the content referred to in FIG. 14 is web content, e.g. it is at least one of a product webpage or a checkout webpage. The content requested by the customer and provided to the customer device 420 by the delivery time information generator 402 may be a checkout webpage, such as the checkout webpage 1200 provided in FIG. 12. The checkout webpage 1200 includes the indication of the delivery time information 1202, which provides the message: “This order is guaranteed to arrive by August 13”. Alternatively, the content requested by the customer and provided to the customer device 420 by the delivery time information generator 402 may be a product webpage, such as product webpage 1300 in FIG. 13. The product page 1300 includes the message: “Customer A, based on your location, this product is guaranteed to arrive by August 13”.

In some embodiments, a system is provided for performing the methods described above. The system may include a memory (e.g. memory 408) to store the data structure (e.g. master delivery timeline table 411). The system may also include at least one processor (e.g. processor 404) to receive, from a user device over a network, a request for content associated with a product and to reply to the request, as described herein.

In some embodiments, a computer-readable medium is provided having stored thereon computer-executable instructions that, when executed by a computer, cause the computer to perform method steps described above, e.g. in relation to FIG. 14.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
receiving, from a user device over a network, a request for content associated with a product; and,
replying to the request, the replying including:
extracting, from a data structure, a probability that the product is delivered within a specific product delivery time window, wherein the data structure is based on:
partitioning a delivery timeline of the product into non-overlapping segments,
for each segment of the non-overlapping segments: computing segment probabilities, wherein at least two of the segment probabilities are each associated with a respective different time duration for completing the segment, and
combining the segment probabilities of the segments to form the data structure, wherein an output obtainable from data structure includes a plurality of probabilities, each of the plurality of probabilities corresponding to a respective different product delivery time window; and,
based on the probability extracted from the data structure, generating an indication including delivery time information relating to the product;
incorporating the indication into the content; and,
transmitting the content over the network for display on the user device.

2. The computer-implemented method of claim 1, wherein the probability extracted from the data structure is extracted based on data in the request.

3. The computer-implemented method of claim 1, wherein the partitioning the delivery timeline comprises configuring a plurality of intermediary data structures, each one of the intermediary data structures corresponding to a respective non-overlapping segment of the delivery timeline, and each one of the intermediary data structures providing an output based on a respective set of inputs, wherein the output is the segment probabilities for the respective non-overlapping segment.

4. The computer-implemented method of claim 3, wherein the combining the segment probabilities comprises multiplying an intermediary data structure probability output by one intermediary data structure with a corresponding intermediary data structure probability output by each of the other intermediary data structures.

5. The computer-implemented method of claim 3, wherein the respective set of inputs of one of the intermediary data structures is different from the respective set of inputs of another of the intermediary data structures, and the inputs to the data structure include a union of all of the inputs to the intermediary data structures.

6. The computer-implemented method of claim 1, wherein inclusion of a delivery time of the product as part of the indication is determined based on the probability extracted from the data structure being within a particular confidence interval.

7. The computer-implemented method of claim 1, wherein the segment probabilities for each non-overlapping segment are computed based on historical time duration data.

8. The computer-implemented method of claim 1, wherein inclusion of a delivery time of the product as part of the indication is determined based on a number of previously provided product delivery times being within a particular range.

9. The computer-implemented method of claim 1, wherein the non-overlapping segments correspond to partitions in time including at least one of:
a time an order is placed to a time a fulfillment center is selected and notified;
the time the order is placed to a time the order is received at a fulfillment network;
the time the order is received at the fulfillment network to the time the fulfillment network selects and notifies the fulfillment center;
the time the fulfillment center is notified to a time when a packaged product is picked up by a carrier;
the time the fulfillment center is notified to a time the product is picked and packaged;
the time the product is picked and packaged to the time when the packaged product is picked up by the carrier; or,
the time the product is picked up by the carrier to a time when the product is delivered.

10. The computer-implemented method of claim 1, wherein the content is at least one of a product webpage or a checkout webpage.

11. A system comprising:
a memory to store a data structure;
at least one processor to:
receive, from a user device over a network, a request for content associated with a product; and,
reply to the request, wherein replying includes:
extracting, from the data structure, a probability that the product is delivered within a specific product delivery time window, wherein the data structure is based on:
partitioning a delivery timeline of the product into non-overlapping segments,
for each segment of the non-overlapping segments: computing segment probabilities, wherein at least two of the segment probabilities are each associated with a respective different time duration for completing the segment, and
combining the segment probabilities of the segments to form the data structure, wherein an output obtainable from the data structure includes a plurality of probabilities, each of the plurality of probabilities corresponding to a respective different product delivery time window; and,
based on the probability extracted from the data structure, generating an indication including delivery time information relating to the product;
incorporating the indication into the content; and,
instructing transmission of the content over the network for display on the user device.

12. The system of claim 11, wherein the probability extracted from the data structure is extracted based on data in the request.

13. The system of claim 11, wherein the at least one processor is to partition the delivery timeline by configuring a plurality of intermediary data structures, each one of the intermediary data structures corresponding to a respective non-overlapping segment of the delivery timeline, and each one of the intermediary data structures providing an output based on a respective set of inputs, wherein the output is the segment probabilities for the respective non-overlapping segment.

14. The system of claim 13, wherein the at least one processor is to combine the segment probabilities by multiplying an intermediary data structure probability output by one intermediary data structure with a corresponding intermediary data structure probability output by each of the other intermediary data structures.

15. The system of claim 13, wherein the respective set of inputs of one of the intermediary data structures is different from the respective set of inputs of another of the intermediary data structures, and the inputs to the data structure include a union of all of the inputs to the intermediary data structures.

16. The system of claim 11, wherein the at least one processor is to determine whether to include a delivery time of the product as part of the indication based on the probability extracted from the data structure being within a particular confidence interval.

17. The system of claim 11, wherein the at least one processor is to compute segment probabilities for each non-overlapping segment based on historical time duration data.

18. The system of claim 11, wherein the at least one processor is to determine whether to include a delivery time of the product as part of the indication based on a number of previously provided product delivery times being within a particular range.

19. The system of claim 11, wherein the non-overlapping segments correspond to partitions in time including at least one of:
a time an order is placed to a time a fulfillment center is selected and notified;
the time the order is placed to a time the order is received at a fulfillment network;
the time the order is received at the fulfillment network to the time the fulfillment network selects and notifies the fulfillment center;
the time the fulfillment center is notified to a time when a packaged product is picked up by a carrier;
the time the fulfillment center is notified to a time the product is picked and packaged;
the time the product is picked and packaged to the time when the packaged product is picked up by the carrier; or,
the time the product is picked up by the carrier to a time when the product is delivered.

20. The system of claim 11, wherein the content is at least one of a product webpage or a checkout webpage.

21. A computer readable medium having stored thereon computer-executable instructions that, when executed by at least one processor, cause the at least one processor to perform operations comprising:
receiving, from a user device over a network, a request for content associated with a product; and,
replying to the request, wherein the replying includes:
extracting, from the data structure, a probability that the product is delivered within a specific product delivery time window, wherein the data structure is based on:
partitioning a delivery timeline of the product into non-overlapping segments,
for each segment of the non-overlapping segments: computing segment probabilities, wherein at least two of the segment probabilities are each associated with a respective different time duration for completing the segment, and
combining the segment probabilities of the segments to form the data structure, wherein an output obtainable from the data structure includes a plurality of probabilities, each of the plurality of probabilities corresponding to a respective different product delivery time window; and,
based on the probability extracted from the data structure, generating an indication including delivery time information relating to the product;
incorporating the indication into the content; and,
transmitting the content over the network for display on the user device.
